(19) United States
(12) Patent Application Publication
(10) Pub. No.: US 2009/0149102 A1
(43) Pub. Date: Jun. 11, 2009

(54) Splittable fibers having break points, use thereof, and device for manufacturing same

(75) Inventors: Engelbert LOCHER, Worms (DE); Norbert GOFFING, Neunkirchen (DE); Klaus KLEIN, Fockelberg (DE); Ararad EMIRZE, Kaiserslautern (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/029,318

(22) Filed: Feb. 11, 2008

(30) Foreign Application Priority Data
Feb. 12, 2007 (DE) 10 2007 006 758.7

(51) Int. Cl. D04H 3/08; D02G 3/36; B29C 47/20

(52) U.S. Cl. 442/335; 428/373; 425/131.5

(57) ABSTRACT

The object of the invention is to provide splittable fibers (6) which on the one hand are very stable during spinning, i.e., do not dissociate during the entire spinning process and the drawing, and on the other hand after spinning and drawing may be dissociated, essentially completely or even up to 100 percent, into segments (10, 12) or individual filaments. A further object is to keep the technical complexity and energy consumption particularly low.

For this purpose, the splittable fibers (6), having at least one break point (8), comprise at least two mutually incompatible polymer components (A, B). At least one polymer component (A) has a lower weight proportion than the other polymer component(s) (B), and the polymer component(s) (A) having the lower weight proportion is situated on and/or in the at least one break point (8).

### TECHNICAL FIELD

The invention relates to splittable fibers having break points, use thereof, and a device for manufacturing same. The fibers contain at least two mutually incompatible polymer components.

### PRIOR ART

Splittable fibers are usually manufactured by simultaneously spinning two or more polymer components from the capillaries of a spinneret, whereby the different polymer components flow in alternation from capillary holes configured in an annular ring. After the fibers are spun and cooled, the individual polymer components may be separated from one another at the respective interfaces of two polymer components.

In this process, for example, a polymer component may be removed by use of a solvent so that the fiber dissociates into fine sections, segments, or individual filaments. Alternatively, it is common to perform separation, disaggregation, or splitting by use of mechanical processes such as needling, compression, in particular sanforizing, creping, or calandering, alone or in any given combination. However, it has not been possible heretofore to satisfactorily achieve complete, i.e., up to 100 percent, dissociation into individual filaments, and therefore splitting is frequently performed by use of water jets.

One disadvantage of splitting by use of water jets, however, is the high energy consumption and the technical complexity of the water treatment. This is because without treating the water, contaminated water may plug individual holes in the water jet nozzles, and as a result fibers or filaments remain unsplit in places, and the yarns or nonwoven fabrics manufactured from staple or continuous fibers, for example, have clearly visible quality defects and flaws.

Use of hollow pie fibers achieves, for example, a significant improvement in the splitting capability and a reduction in energy consumption compared to solid pie fibers.

EP 0 087 292 B1 describes hollow polyester filaments, the outer surface of the filament having the shape of multiple ridges and grooves extending in the longitudinal direction of the filament, and the filament having an elongation at break of less than 30%.

### DESCRIPTION OF THE INVENTION

The object of the invention is to provide splittable fibers which on the one hand are very stable during spinning, i.e., do not dissociate during the entire spinning process and the drawing, and on the other hand after spinning and drawing may be dissociated, essentially completely or even up to 100 percent, into segments or individual filaments. A further object is to keep the technical complexity and energy consumption particularly low.

This applies in particular to splitting by use of water jets, without, however, being limited to this type of splitting. The desired splittable fibers should be particularly easy to separate, regardless of the type of splitting.

A further object is to provide possible applications of such splittable fibers and a device for manufacturing same.

The stated objects with regard to the fibers are achieved by the features of claim 1.

For this purpose, splittable fibers are provided which have break points, in particular notches, and which comprise at least two mutually incompatible polymer components, at least one polymer component having a lower weight proportion than the other polymer component(s), and the polymer component(s) with the lower weight proportion being situated on and/or in the break points.

In this context, fibers are understood to mean staple fibers, continuous fibers, or filaments. Fibers that are spun into yarns are also included. The fibers may also be combined into fleeces, in particular bonded fleeces, for nonwoven fabrics.

The subclaims state advantageous refinements of the subject matter of the invention.

In one preferred embodiment the break points or notches of the splittable fibers are completely or partially filled by the at least one polymer component having the lower weight proportion (referred to as the minor component). As a result, the splittable fibers in particular remain held together during the spinning and subsequent drawing.

For low material consumption, in particular with regard to cost reduction and/or environmental compatibility, splittable fibers are provided whose at least one polymer component having a lower weight proportion advantageously has a weight proportion of less than or equal to 10 or 20% by weight, preferably less than or equal to 5% by weight, particularly preferably less than or equal to 3% by weight.

To further reduce the complexity of splitting the fibers, the splittable fibers are preferably provided as hollow fibers having break points or notches in the ring or edge.

For particularly good splitting capability, the splittable fibers are preferably provided as flat fibers having break points or notches.

Advantageous embodiments of the splittable fibers are circular and/or polygonal cross-sectional shapes, the break points or notches having circular, rounded, straight, rod-like, polygonal, and/or pointed shapes, and particularly preferably being located in the center and/or edge, and/or at the ends, corners, and/or tips, of the fibers.

As preferred materials for the splittable fibers, polymer components selected from thermoplastic polymers have proven to be suitable, in particular polyesters, preferably polyethylene terephthalate (PET), or polyolefins, preferably polyethylene (PE) and/or polypropylene (PP), or polylactates and/or polyamides (PA).

For bicomponent fibers, combinations of mutually incompatible polymer components are selected, preferably composed of PET and PP, PET and PA6, PET and PA6.6, or PP and PE.

For the splittable fibers it is advantageous for the polymer component having a lower weight proportion to be a polymer component with a lower melting temperature.

In one preferred embodiment, in particular with regard to simple and economical manufacture of nonwoven fabrics from the splittable fibers or filaments, at least one polymer component having a lower weight proportion is used as an adhesive or binding component. As the result of using this minor component as a binder, for example, felting by use of needles or bonding by use of water jets is no longer necessary, so that the expenditure of time and energy may also be reduced in the processing of the fibers or filaments.

Furthermore, for a polymer combination, for example of polyethylene terephthalate and polyolefin, preferably polypropylene, which is used as a minor component, the bonding of the nonwoven fabric by compression and subsequent fusion of the polyolefin component in a convection oven take place at a temperature which is greater than the melting temperature of the polyolefin component and is less than the melting temperature of the polyethylene terephthalate.

The splittable fibers according to the invention are preferably used for manufacturing nonwoven fabrics, in particular for filters, clothing, hygienic or cleaning products, or tufted products, in particular carpet backings.

To provide the referenced splittable fibers with break points which on the one hand are very stable during spinning and on the other hand after spinning and drawing may be dissociated, essentially completely or even up to 100 percent, into segments or individual filaments, while also being able to keep the technical complexity and energy expenditure particularly low, according to the invention the device for manufacturing the splittable fibers has special spinning capillaries. The spinning capillaries have constrictions which correspond to the break points or notches in the fibers, in particular for partially or completely filling with the polymer component(s) having a lower weight proportion.

As a result of this design of the device, the polymer melt stream is constricted or diverted at the locations to be subsequently split, so that the particular fiber acquires a weak point at that location. The dissociation or splitting of the filament is facilitated by appropriate positioning of the incompatible polymer component(s) having a lower weight proportion.

In one preferred embodiment of the device, the capillaries have cross-sectional shapes which correspond to the predetermined cross-sectional shapes of the fibers.

As a result of the special design of the capillaries for manufacturing the bi- or multicomponent fibers according to the invention, having break points or notches at and/or in which one component having a lower weight proportion than the other component(s) is provided, it is possible for the fibers in question to remain together during the drawing, and to be split in a predetermined manner only later by means of mechanical and/or hydrodynamic stress, with particularly low expenditure of energy and particularly good productivity, thus allowing high-quality products to be manufactured.

### EXECUTION OF THE INVENTION

The subject matter of the invention is explained in greater detail with reference to examples, without limiting the invention.

The drawings show the following:

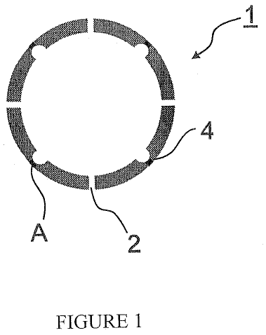

FIG. 1: shows a top view of a cross-sectional shape of a spinning capillary for bicomponent fibers comprising polymer components A (black) and B (gray);

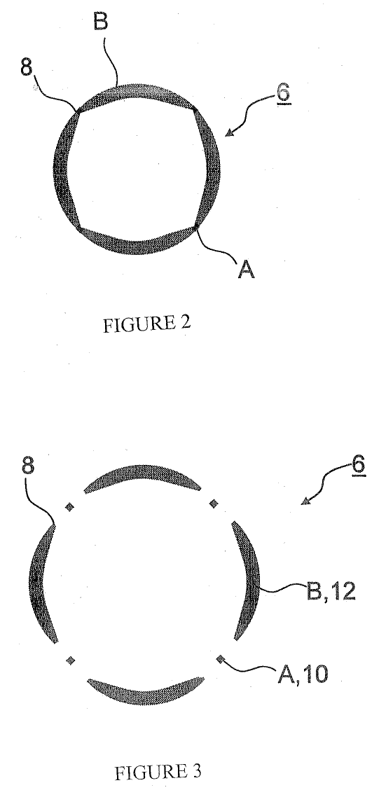

FIG. 2: shows a top view of a cross-sectional shape of a splittable fiber having an essentially circular cross-sectional shape and having break points, after spinning through the capillary according to FIG. 1, and after drawing; and

FIG. 3 shows a top view of a cross-sectional shape of fiber segments after splitting of the splittable fiber according to FIG. 2.

Splittable multicomponent fibers are usually manufactured by spinning two or more polymers from capillaries in a spinneret. After the fibers are spun and drawn, the individual polymer components or segments may be separated from one another at the interfaces of two polymers.

FIG. 1 shows by way of example a capillary 1 having ridges 2 and constrictions 4 for manufacturing essentially circular bicomponent hollow fibers having break points or notches, one polymer component A (black), which has a lower weight proportion than the other polymer component B (gray), being provided at the constrictions 4 in the capillary 1, as shown in FIG. 1.

FIG. 2 illustrates the cross section of an essentially circular hollow splittable fiber 6, composed of the polymer components A and B and having rounded break points 8, in particular notches, after spinning from the capillary 1 according to FIG. 1 and after drawing, whereby polymer component A (black), which has a lower weight proportion (minor component), is provided at the break points 8 of the fiber 6, and the break points 8 are partially filled, thereby holding the fiber 6 together until the splitting.

FIG. 3 shows individual fiber segments 10, 12 of the fiber 6 composed of polymer components A and B from FIG. 2, after splitting, the fiber segments 10 of the minor component A (black) having a polygonal cross-sectional shape, and the fiber segments 12 of the major component B (gray) having a slotted and curved cross-sectional shape.

Of course, any number of other cross-sectional shapes of the spinning capillaries 1 may be provided, corresponding to the fibers 6 spun therefrom, whereby the break points 8 or notches are provided in the center, at the edge, or on the ends, corners, and/or tips of the fibers 6, and the break points 8 or notches may likewise have any given circular, rounded, straight, rod-like, polygonal, and/or pointed cross-sectional shapes. This also applies to the split segments 10, 12 or individual filaments of the fibers 6.

The special design of the fibers 6 results in a particularly well-controllable and energy-favorable splitting into predetermined individual filaments or segments 10, 12, with a particularly high yield and quality. High-quality products may thus be manufactured from same in a particularly economical manner.

What is claimed is:

1. Splittable fibers having at least one break point, and comprising at least two mutually incompatible polymer components, at least one polymer component having a lower weight proportion than the other polymer component, and the polymer component having the lower weight proportion being situated on and/or in the at least one break point.

2. Splittable fibers according to claim 1, the break points of which are completely or partially filled by the at least one polymer component having the lower weight proportion.

3. Splittable fibers according to claim 1, wherein at least one polymer component has a weight proportion of less than or equal to 20% by weight, preferably less than or equal to 10% by weight, particularly preferably less than or equal to 5% by weight, very particularly preferably less than or equal to 3% by weight.

4. Splittable fibers according to claim 1, provided as hollow fibers or filaments having break points in the ring or edge.

5. Splittable fibers according to claim 1, provided as flat and/or solid fibers having break points.

6. Splittable fibers according to claim 1, having circular and/or polygonal cross-sectional shapes, and having break points which are circular, rounded, straight, rod-shaped, polygonal, and/or pointed.

7. Splittable fibers according to claim 1, having circular and/or polygonal cross-sectional shapes, and having break points which are located in the center and/or edge, and/or at the ends, corners, and/or tips, of the fibers.

8. Splittable fibers according to claim 1, wherein the polymer components are selected from thermoplastic polymers, including polyesters, polyethylene terephthalate, polyolefins, polyethylene and/or polypropylene, or polylactates and/or polyamides.

9. Splittable fibers according to claim 1, wherein a polymer component with a lower melting temperature is selected as the polymer component having a lower weight proportion.

10. Splittable fibers according to claim 1, wherein at least one polymer components having a lower weight proportion is used as an adhesive or binding component.

11. Use of splittable fibers, manufactured by a method according to claim 1, for producing nonwoven fabrics, in particular for filters, clothing, hygienic or cleaning products, or tufted products, in particular carpet backings.

12. Device for manufacturing the splittable fibers according to claim 1, wherein the spinning capillaries have constrictions which correspond to the break points in the fibers, in particular for partially or completely filling, for the polymer component having a lower weight proportion.

13. Device for manufacturing the splittable fibers according to claim 12, wherein the spinning capillaries have cross-sectional shapes which correspond to the predetermined cross-sectional shapes of the fibers.
